(19) United States
(12) Patent Application Publication
(10) Pub. No.: US 2008/0140890 A1
(43) Pub. Date: Jun. 12, 2008

(54) Electronic Circuit Arrangement For Detecting a Failing Clock

(75) Inventor: Franciscus J. Klosters, Schaijk (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V., Eindhoven (NL)

(21) Appl. No.: 10/590,405

(22) PCT Filed: Feb. 15, 2005
(86) PCT No.: PCT/IB05/50575

§ 371 Date: Oct. 30, 2007

(30) Foreign Application Priority Data
Feb. 27, 2004 (EP) 04100789.9

(51) Int. Cl. G06F 13/00

(52) U.S. Cl. 710/107

(57) ABSTRACT

The invention relates to an electronic circuit arrangement (300) comprising a clock fail circuit (302) arranged for receiving a clock signal circuit (303) and generating an error signal upon the absence of the clock signal. The electronic circuit arrangement (300) further comprises an asynchronous processor (301) arranged for receiving said error signal on an interrupt input INT and to bring the electronic circuit arrangement in a pre-defined state upon detection of the error signal at the interrupt input INT by executing an interrupt routine.

The invention relates to an electronic circuit arrangement as defined in the preamble of claim 1.

The invention also relates to a an integrated circuit, a bus station, and a method for bringing a electronic circuit arrangement in a predetermined state.

Such an electronic circuit arrangement is disclosed in U.S. Pat. No. 6,343,334. It comprises a clock fail circuit arranged for receiving an external clock signal. The disclosed electronic circuit arrangement is a micro computer that further comprises a reset generation circuit and a synchronous micro processor operating under control of the external clock signal. In case of a failing clock signal, for instance a clock signal having a frequency that is too low or in the absence of a clock signal the clock fail circuit generates a reset signal to reset the micro computer or exchanges the external clock signal with an internal clock signal generated by a clock circuit that is part of the micro computer.

In the absence of a clock signal the operation of the microprocessor is halted. Therefore the additional hardware such as the internal clock circuit or a reset circuit to reset the microprocessor and turn off outputs of the micro computer is required. This increases design complexity of the electronic circuit arrangement.

Amongst others it is an object of the invention to provide an electronic circuit arrangement having a reduced complexity.

To this end the invention provides electronic circuit arrangement as defined in the opening paragraph which is characterized by the features of the characterizing part of claim 1.

By providing an electronic circuit arrangement comprising an asynchronous processor, the presence of a clock signal is not required for operation of the processor. Therefore the asynchronous processor can bring the electronic circuit arrangement in a pre-defined state upon detection of the error signal, thereby circumventing the need for additional hardware such as an internal clock circuit for taking over the function of a failing external clock or a reset circuit for resetting the electronic circuit arrangement. This reduces the design complexity of the electronic circuit arrangement.

A further advantage of the use of an asynchronous processor is that it may lead to a reduced power consumption. The operation of an asynchronous processor is event triggered. As long as there are no events, the state of the processor does not change and consequently it does not consume power. Only upon reception of a trigger, such as for instance the error signal, it starts or continues operation.

The above and other objects and features of the present invention will become more apparent from the following detailed description considered in connection with the accompanying drawings in which:

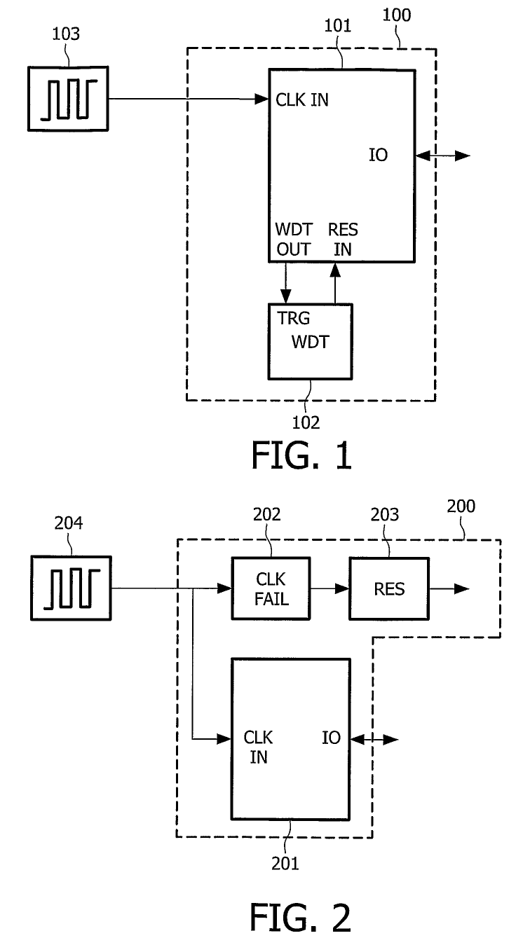

FIG. 1 shows a prior art electronic circuit arrangement for detecting a clock failure;

FIG. 2 shows another prior art electronic circuit arrangement for detecting a clock failure;

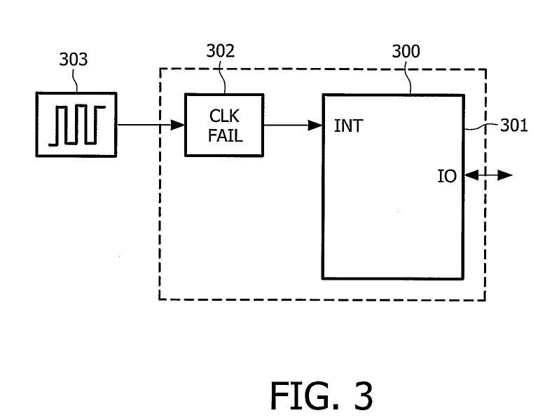

FIG. 3 shows an electronic circuit arrangement according to the invention for detecting a clock failure;

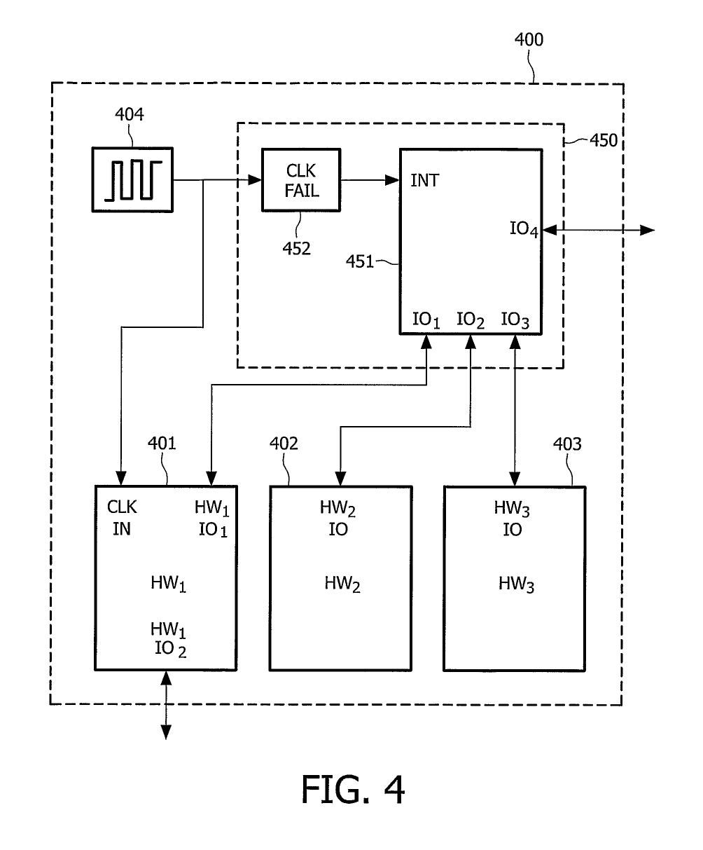

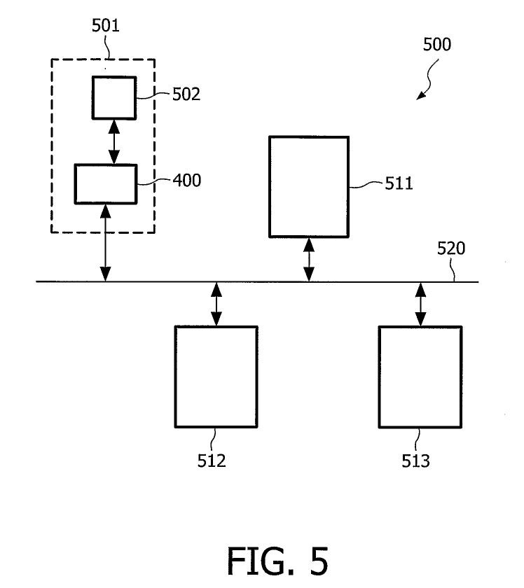

FIG. 4 shows an integrated circuit comprising the electronic circuit arrangement; and

FIG. 5 shows a bus system having a bus station comprising the electronic circuit arrangement according to the invention.

In these figures identical parts are identified with identical references.

FIG. 1 shows a prior art electronic circuit arrangement for detecting a clock failure. The electronic circuit arrangement 100 comprises a synchronous processor 101 and a watchdog timer (WDT) 102. The processor 101 operates under control of a clock signal 30 generated by a clock generation circuit 103. Watchdog timer 102 includes a resetable timer, for instance a resetable counter or resetable integrator integrating a reference signal. In case the counter or the integrated reference signal exceeds a predefined threshold value, the watchdog timer generates a reset signal that is received on a reset input (RES IN) of processor 101, thereby triggering a reset of processor 101. In normal operation processor 101 periodically generates a watchdog trigger signal at an output (WDT OUT). The watchdog trigger signal resets the timer, thereby preventing that watchdog timer 102 generates a reset signal. By means of the watchdog timer 102 it is therefore possible to restart or reset processor 101, i.e. bring it in a predefined state, in case operation of processor 101 is halted for some reason, for instance a bug in the program it is running or a disturbance causing some hardware within the processor to temporarily stop operation. The reset signal is also generated in case the clock fails, either entirely or for instance by running on a too low frequency.

The electronic circuit arrangement 100 has several disadvantages. For instance it is not possible to distinguish between a failing clock and an error condition within processor 101 causing it to stop operating. Furthermore the electronic circuit arrangement 100 requires additional hardware in case the clock fails and the electronic circuit arrangement has to be brought into a predefined state in which for instance the input/output terminal or terminals (IO) of processor 101 have to be shut down or other electronic circuits not shown in FIG. 1. Just applying a reset signal to processor 100 will not suffice, since its operation is halted in the absence of the clock signal.

FIG. 2 shows another prior art electronic circuit arrangement for detecting a clock failure. The electronic circuit arrangement 200 comprises a synchronous processor 201, a clock fail detection circuit (CLK FAIL) 202, and a reset generation circuit (RES) 203. The processor 201 operates under control of a clock signal generated by a clock generation circuit 204, which it receives at a clock input (CLK IN). Processor 201 further comprises one or more inputs and outputs for communicating with other electronic circuits. Clock fail detection circuit 202 monitors the clock signal generated by clock generation circuit 204. In case clock generation circuit 204 fails, either because the generated clock frequency is too low or no clock signal is generated at all, it will generate an error signal. This error signal is received by reset generation circuit 203, which in response generates a reset signal, which is used to bring the electronic circuit arrangement 200 in a predefined state for instance by causing a reset or by shutting down external inputs and outputs. This is not shown in FIG. 2. Alternatively it may provide another clock signal—generated for instance by an internal clock circuit—to processor 201 and other parts of the electronic circuit arrangement to enable. This is not shown in FIG. 2.

Clock fail detection circuit 202 may be the same or similar as the watchdog timer 102 shown in FIG. 1.

An advantage of electronic circuit arrangement 200 over electronic circuit arrangement 100 is that is possible to distinguish a failing clock generation circuit from a failing processor. However electronic circuit arrangement is still rather complex, because it requires additional hardware to take care of a failing clock condition.

FIG. 3 shows an electronic circuit arrangement according to the invention for detecting a clock failure. The electronic circuit arrangement 300 according to the invention comprises an asynchronous processor 301 and a clock fail detection circuit (CLK FAIL) 302. The operation of the asynchronous processor is event triggered and therefore not dependent upon the presence of a clock signal. It comprises an interrupt input INT and one ore more inputs and outputs (IO). The clock fail circuit 302 monitors the clock signal generated by the clock generation circuit 303. Its operation is similar to the operation of watchdog timer 102. It may comprise a resetable timer, for instance a resetable counter or resetable integrator integrating a reference signal. In case the counter or the integrated reference signal exceeds a predefined threshold value, clock fail detection circuit 302 generates an interrupt signal that is received on interrupt input (INT) of processor 301, thereby triggering the execution of software routine handling the condition of a failing clock circuit without requiring additional hardware as is the case with the known electronic circuit arrangements shown in FIG. 1 and FIG. 2.

A further advantage of the electronic circuit arrangement is that its operation can be modified by changing the interrupt handling software routine without the necessity of a hardware modification. This increases the flexibility of electronic circuit arrangement 300, since the same hardware may be applied in different application having different requirements with respect to handling of a failing clock generation circuit.

FIG. 4 shows an integrated circuit comprising the electronic circuit arrangement. The integrated circuit 400 comprises an electronic circuit arrangement 450 according to the invention. The electronic circuit arrangement 450 comprises an asynchronous processor 451 and a clock fail detection circuit (CLK FAIL) 451. The integrated circuit further comprises a clock generation circuit 404 and additional electronic circuit arrangements HW1 401, HW2 402, and HW3 403.

Asynchronous processor 451 comprises an interrupt input (INT) for receiving an input signal. It further comprises one or more inputs and/or outputs IO1, IO2, and IO3 for communicating with the further electronic circuit arrangements HW1, HW2, and HW3 respectively. It further comprises one or more input and/or outputs IO4 for communicating with other electronic circuits, for instance a system processor.

Electronic circuit arrangement HW1 is a synchronous electronic circuit and operates under control of the clock signal generated by clock signal generation circuit 404. It comprises a clock input CLK IN for receiving the clock signal one or more inputs and/or outputs HW1 IO1 for communicating with processor 451 and one or more external inputs and/or outputs HW1 IO2 for communicating with other electronics.

Electronic circuit arrangement HW2 is asynchronous and therefore does not require a clock signal for its operation. For communication with processor 451 it comprises on or more inputs and/or outputs HW2 IO.

Electronic circuit arrangement HW3 is also asynchronous and therefore does not require a clock signal for its operation. For communication with processor 451 it comprises on or more inputs and/or outputs HW3 IO.

In a similar way as in electronic circuit arrangement 400 clock fail circuit 452 will generate an interrupt on interrupt input INT of processor 451 in case of a failing clock.

In a typical application electronic circuit arrangement HW1 may be used for handling time critical or real time tasks, for instance handling communications with other electronics circuits via input/output terminals HW1 IO2 in which lengths of pulses or delays between pulses need to be determined. In such an application it may be advantageous to use asynchronous electronics for a part of the circuit to reduce power consumption. If nothing relevant happens no events are triggered and the state of the asynchronous electronics does not change. Consequently the asynchronous electronics does not consume power. At the same time the synchronous electronics remains operational for performing time critical or real time task. If required the synchronous electronics HW1 can initiate communication with processor 451, thereby creating an event by which processor 451 will be triggered to execute the required operations possibly also involving the other asynchronous electronics HW2 and/or HW3.

In the same way failure of the clock generation circuit will also generate an event by which processor is triggered. It may for instance respond by resetting the clock generation circuit or shutting down the external input/output terminals HW1 IO2 of HW1, or signaling malfunctioning to other electronics via its own input/output terminals IO4.

In a completely synchronous environment additional measures would have been required to shut down the parts that do not have to be operational to preserve energy or to reduce power consumption. At the other hand in a completely asynchronous environment it is not possible to perform time critical or real time tasks.

FIG. 5 shows a bus system having a bus station comprising the electronic circuit arrangement according to the invention. The bus system 500 comprises bus station 501 and further bus stations 511, 512, and 513. The bus stations are arranged to communicate with each other via the bus 520. Bus station 501 comprises integrated circuit 400 and further hardware 502. The further hardware may be for instance a system processor of bus station 501. Bus system 500 may be for instance a LIN bus system as used in automotive applications. In such a system energy conservation is very important, since once a motor of a car is turned off all electronics will have to be operated from the battery. At the same time the operation of the bus system needs to be real time, since certain response times need to be guaranteed.

In summary the invention relates to an electronic circuit arrangement comprising a clock fail circuit arranged for receiving a clock signal generated by a clock generation circuit and generating an error signal upon the absence of the clock signal. The electronic circuit arrangement further comprises an asynchronous processor arranged for receiving said error signal on an interrupt input and to bring the electronic circuit arrangement in a pre-defined state upon detection of the error signal at the interrupt input by executing an interrupt routine.

The embodiments of the present invention described herein are intended to be taken in an illustrative and not a limiting sense. Various modifications may be made to these embodiments by those skilled in the art without departing from the scope of the present invention as defined in the appended claims.

For instance in the embodiments discussed in connection with FIG. 3, FIG. 4, and FIG. 5 the processors may be micro processors or micro controllers executing instructions stored as software in a memory. Alternatively the instructions may be hard coded in the processor itself as is the case in for instance state machines.

Furthermore the clock generation circuits shown in the embodiments of FIG. 3 and FIG. 4 are not a part of electronic circuit arrangements 300 and 450. Alternative these could be included in the electronic circuit arrangements.

Furthermore, although the embodiment of FIG. 4 is shown in the form of an integrated circuit, it will be clear that the various parts: electronic circuit arrangement 450, further electronic circuit arrangements 401, 402, and 403, and clock generation circuit 404 may be realized as individual integrated circuits, while the whole arrangement 400 is realized by placing the various parts on an printed circuit board with interconnect for connecting them with each other.

1. An electronic circuit arrangement comprising a clock fail circuit arranged for receiving a clock signal and generating an error signal upon the absence of the clock signal, characterized in that the electronic circuit arrangement further comprises an asynchronous processor arranged for receiving said error signal and to bring the electronic circuit arrangement in a pre-defined state upon detection of the error signal.

2. An electronic circuit arrangement as claimed in claim 1, characterized in that the asynchronous processor comprises an interrupt input for receiving the error signal and is further arranged to execute software instructions upon reception of the error signal.

3. An integrated circuit comprising an electronic circuit arrangement as claimed in claim 1.

4. A bus station for use in a bus system comprising an electronic circuit arrangement as claimed in claim 1.

5. A bus station as claimed in claim 3, characterized in that the bus station is a bus station for use in a LIN bus system.

6. A method for bringing an electronic circuit arrangement in a predetermined state, whereby the electronic circuit arrangement comprises a clock fail circuit that detects the absence of a clock signal and generates an error signal in response, characterized in that the electronic circuit arrangement further comprises an asynchronous processor that brings the electronic circuit arrangement in the predetermined state.
